(19) United States
(12) Patent Application Publication
(10) Pub. No.: US 2024/0295643 A1
(43) Pub. Date: Sep. 5, 2024

(54) METHOD FOR CLASSIFYING AN OBJECT TO BE DETECTED WITH AT LEAST ONE ULTRASONIC SENSOR

(71) Applicant: Robert Bosch GmbH, Stuttgart (DE)

(72) Inventors: Andre Gerlach, Leonberg-Hoefingen (DE); Jona Eisele, Kornwestheim (DE)

(21) Appl. No.: 18/434,799

(22) Filed: Feb. 6, 2024

(30) Foreign Application Priority Data
Mar. 1, 2023 (DE) 10 2023 201 850.0
Mar. 10, 2023 (DE) 10 2023 202 159.5

(51) Int. Cl. G01S 7/52; G01S 15/02

(52) U.S. Cl. CPC G01S 7/52001; G01S 15/02

(57) ABSTRACT

A method for classifying an object to be detected with at least one ultrasonic sensor. The method includes: transmitting a first signal using the ultrasonic sensor to the object; receiving a second signal using the ultrasonic sensor, wherein the second signal is a backscattered signal from the object; processing the second signal into a digital signal; extracting a selected signal portion from the digital signal, the selected signal portion representing a relevant and time-limited time segment from the digital signal; transforming the selected signal portion into a two-dimensional feature vector; feeding the two-dimensional feature vector into a neural network as at least one input variable; determining object class information for the object using the neural network, wherein, based on the at least one input variable, the neural network produces an output variable which indicates a probability value for at least one defined object class for the one object.

### CROSS REFERENCE

The present application claims the benefit under 35 U.S.C. § 119 of German Patent Application Nos. DE 10 2023 201 850.0 filed on Mar. 1, 2023, and DE 10 2023 202 159.5 filed on Mar. 10, 2023, which are both expressly incorporated herein in their entireties.

### FIELD

The present invention relates to a method for classifying an object to be detected with at least one ultrasonic sensor.

### BACKGROUND INFORMATION

Ultrasonic sensors are used in automotive and industrial applications, for example in a parking assistance system of a vehicle, to determine distance and detect objects in the surroundings.

Ultrasonic sensors operate according to the well-known pulse-echo principle. An electrical signal excites a transducer to vibrations on its membrane, which are emitted as sound. The sound travels through the air until it meets an object in the surroundings. The surface of the object reflects the sound, which causes backscattering in the direction of the ultrasonic sensor. When the backscattered sound hits the membrane, it causes it to vibrate and creates an electrical signal at the piezo element.

State-of-the-art ultrasonic sensors nowadays measure the transit time of the sound from its emission to its return. The known speed of sound propagation can be used to ascertain the distance to the backscattering object.

However, even though the sound pressure of the backscatter in its physical nature is a quantity with a temporal progression, to date the time signal has not been fully utilized; in particular for reasons of cost and for reasons of simple data acquisition, data storage and data transmission. After several signal preprocessing steps, such as filtering, amplitude values and associated correlation values that represent the large values in the sound pressure time signal are individually formed by means of threshold value formation methods using simple or even more complex and adaptive methods. An echo from an object is therefore detected by comparing the reception amplitude of the sound with a threshold value. Typically, only the echoes the amplitude of which is above the threshold value are considered relevant and further evaluated. However, state-of-the-art ultrasonic sensors only transmit the few amplitude or correlation values which are often referred to as echo values. This impairs accuracy in the differentiation of objects by means of sensors or in the determination of object dimensions.

It is an object of the present invention to provide a solution, by means of which the performance of an ultrasonic sensor and thus the detection of objects in the surroundings of a vehicle with an ultrasonic sensor can be improved in an efficient and reliable manner.

### SUMMARY

This object may be achieved by a method for classifying an object to be detected with at least one ultrasonic sensor having features of the present invention.

According to a first aspect, the present invention relates to a method for classifying an object to be detected with at least one ultrasonic sensor. According to an example embodiment of the present invention, the method comprises the following steps:

In a first step, a first signal is transmitted by means of the at least one ultrasonic sensor to the object.

In a second step, a second signal is received by means of the at least one ultrasonic sensor, wherein the second signal is a backscattered signal from the object.

In a third step, the second signal is processed into a digital signal.

In a fourth step, a selected signal portion is extracted from the digital signal, wherein the selected signal portion represents a relevant and time-limited time segment from the digital signal.

In a fifth step, the selected signal portion is transformed into a two-dimensional feature vector.

In a sixth step, the at least one two-dimensional feature vector is fed into a neural network as at least one input variable.

In a seventh step, object class information for the one object is determined using the neural network, wherein, based on the at least one input variable, the neural network produces an output variable which indicates a probability value for at least one defined object class for the one object.

A basic feature of the present invention is that an ultrasonic sensor is not only used to ascertain distances between the sensor and objects, but that the acquired sensor data of the ultrasonic sensor are used to classify objects. In a classification, the type or the characteristic properties of objects are determined from backscattered ultrasonic signals.

Based on the classification, groups of objects, so-called object classes, and not only a single individual or a single representative of a detected object, can be determined by means of sensors. Typical object classes can, for example, be: people, poles, trees, curbs, small objects, manhole covers, etc. Aggregated classes, such as can be driven over/cannot be driven over, can be classified as well.

Knowledge of the class affiliation advantageously creates many opportunities for more efficient driving functions. For example, it is very helpful to differentiate between objects that are static and objects that can move or objects that can be driven over and objects that cannot be driven over. Further information to support the driving function can advantageously be derived from the knowledge of class affiliation directly, indirectly, or in combination with other information or sensors. This information is in particular relevant and applicable for complex or safety-related driving functions, such as highly or fully automated driving.

One example embodiment of the method of the present invention provides that the selected signal portion from the digital signal represents a fixed time period from an ascertained starting point of the digital signal. The advantage of this is that the length of the selected signal portion can be determined efficiently.

One example embodiment of the method of the present invention provides that the selected signal portion is ascertained from the digital signal using a sliding window approach or a pulse-echo method, wherein a window which is shorter than the entire recording length of the digital signal is shifted over an entire recording length of the digital signal. The advantage of this is that an efficient classification of detected objects can be achieved.

One example embodiment of the method of the present invention provides that the step of processing the second signal into a digital signal includes filtering the digital signal to improve an S/N ratio. This advantageously makes it possible to achieve a better signal quality.

One example embodiment of the method of the present invention provides that feeding at least one further input variable into the neural network is provided, wherein the second input variable includes distance information which represents a distance between the at least one ultrasonic sensor and the one object. The advantage of this is that it enables efficient classification of the object.

One example embodiment of the method of the present invention provides that the distance information is fed as an intermediate feed into a posterior classifier portion of (fully) connected layers of the neural network. The advantage of this is that it improves the correct classification rates for the object.

One example embodiment of the method of the present invention provides that the neural network comprises at least one first convolutional layer with a non-square filter kernel, the narrow side of which extends along the time dimension of the feature vector, and a second convolutional layer with a non-square filter kernel, the narrow side of which extends along the frequency dimension of the feature vector. The advantage of this is that it enables efficient classification of the object. Another advantage is that it achieves a very compact and meaningful depiction of features with respect to time progression and frequency content.

One example embodiment of the method of the present invention provides that the second signal is configured as an analog signal. The advantage of this is that, as a raw signal, the second signal contains a maximum bandwidth of information with little loss that can be used for further processing of the signal.

According to a second aspect, the present invention relates to a detection system for classifying an object to be detected. According to an example embodiment of the present invention, the detection system comprises at least one ultrasonic sensor (50) which is configured to carry out the method according to the invention, wherein the at least one ultrasonic sensor can be used in a vehicle.

According to a third aspect, the present invention relates to a computer program comprising machine-readable instructions which, when executed on one or more computers and/or compute instances, cause said computers and/or compute instances to carry out the method according to the present invention.

According to a fourth aspect, the present invention relates to a machine-readable data carrier and/or download product comprising the computer program according to the present invention.

According to a fifth aspect, the present invention relates to one or more computers and/or compute instances comprising the computer program and/or comprising the machine-readable data carrier and/or the download product, according to the present invention.

Further measures improving the present invention are shown in more detail below, together with the description of the preferred embodiment examples of the present invention, with reference to the figures.

### BRIEF DESCRIPTION OF THE DRAWINGS

FIG. 1 shows a schematic flowchart of the method 100 for classifying an object 10 to be detected with at least one ultrasonic sensor 50, according to an example embodiment of the present invention.

FIG. 2 shows a schematic illustration of a detection system 200 for carrying out the method 100 according to an example embodiment of the present invention.

FIG. 3 shows a schematic illustration of training a neural network 9 using the method 100 according to an example embodiment of the present invention.

### DETAILED DESCRIPTION OF EXAMPLE EMBODIMENTS

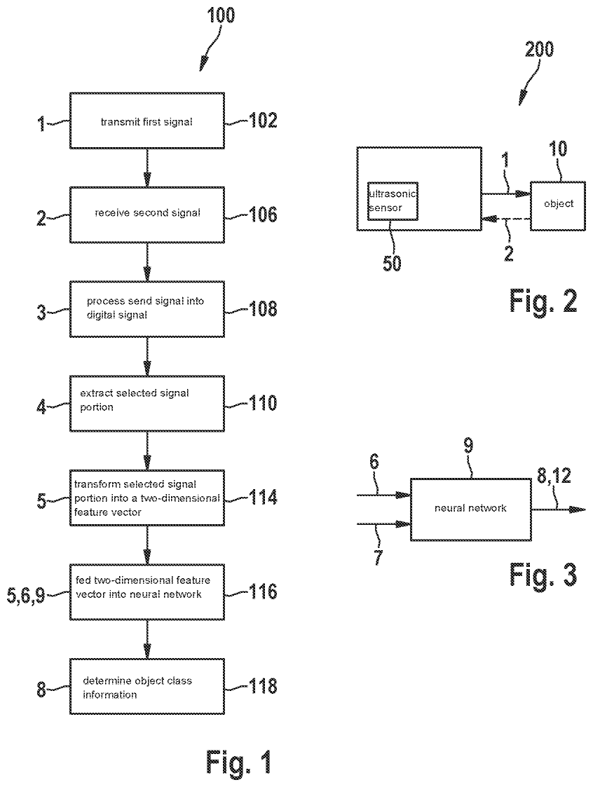

FIG. 1 shows a schematic flowchart of the method 100 for classifying an object 10 to be detected with at least one ultrasonic sensor 50.

In Step 102, a first signal 1 is transmitted by means of the at least one ultrasonic sensor 50 to the object 10.

In Step 106, a second signal 2 is received by means of the at least one ultrasonic sensor 50, wherein the second signal 2 is a backscattered signal from the object 10. The second signal 2 is preferably analog signal. The analog signal 2 can be a high-resolution time signal obtained after A/D sampling, which represents the sound pressure in compliance with the Nyquist theorem. Simply stated, the analog signal 2 is therefore the sound pressure of the backscatter from the object 10 in the air.

In Step 108, the second signal 2 is processed into a digital signal 3. The processing of the second signal 2 can involve an analog/digital (AD) conversion, for example. The Step 108 of processing the second signal 2 into a digital signal 3 can also include filtering the digital signal 3 (advantageously after the A/D converter stage) to improve an S/N ratio. The filtering can be carried out using appropriate-seeming filters, such as low-pass filters, high-pass filters or band-pass filters.

In Step 110, a selected signal portion 4 is extracted from the digital signal 3, wherein the selected signal portion 4 represents a relevant and time-limited time segment from the digital signal 3. The selected signal portion 4 could optionally be subjected to a plausibility check to ensure a required quality of the extracted signal portion 4.

The selected signal portion 4 from the digital signal 3 represents a fixed time period from an ascertained starting point of the digital signal 3. The start time can be set using the pulse-echo method.

The selected signal portion 4 from the digital signal 3 can be ascertained using a sliding window approach or a pulse-echo method. This involves shifting a window which is shorter than the entire recording length of the digital signal 3 over an entire recording length of the digital signal 3, over the entire time or recording length of the signal 3. The sliding window approach is provided as an alternative to known echo-pulse methods for setting start times. However, the window length has to be set to a fixed value in both cases.

Or, in other words: in the sliding window approach, a window which is shorter than the entire length of the recording of the digital signal 3 is shifted over the entire recording length of the digital signal 3. A plurality of fixed start times can be implemented. This ensures that the individual window sections overlap, so that each window later receives an assigned classification.

In Step 114, the selected signal portion 4 is transformed 114 into a two-dimensional feature vector 5. The feature vector can alternatively also be multidimensional.

In Step 116, the at least one two-dimensional feature vector 5 is fed into a neural network 9 as at least one input variable 6. The neural network 9 can be contained both in the ultrasonic sensor 50 and in an associated control unit. If the neural network 9 is a component of a control unit (for example in a vehicle), the configuration of ultrasonic sensor 50 can be as simple as possible, which makes the ultrasonic sensor more cost-efficient.

The step 116 of feeding can involve providing at least one further input variable 7 to the neural network 9. The at least second input variable 7 includes distance information which represents a distance between the at least one ultrasonic sensor 50 and the one object 10.

It is important that feeding an additional feature “distance to the object” as the second input variable 7 does not take place before the first CNN layers, but rather as an intermediate feed into the posterior classifier portion of the fully connected layers. With respect to ultrasound, the properties of the objects to be classified are strongly influenced by the distance.

Therefore, this feature significantly improves the correct classification rates for the object 10.

In Step 118, object class information 12 for the one object 10 is determined using the neural network 9, wherein, based on the at least one input variable 6, the neural network 9 produces an output variable 8 which indicates a probability value for at least one defined object class for the one object 10.

FIG. 2 shows a schematic illustration of a detection system 200 for carrying out the method 100 according to an embodiment of the present invention. The detection system 200 comprises an ultrasonic sensor 50 that transmits a first signal 1 to the object 10 to be detected and classified. This first signal 1 is reflected by the object 10 and reaches the ultrasonic sensor 50 in the form of the second signal 2, which is processed in the above-described manner according to the method 100 according to the invention in order to classify the object 10.

In this context, it can generally be said that the ultrasonic time signal (=raw signal) backscattered by the object 10 and acquired by means of sensors is being used. The second signal 2 corresponds to the raw signal.

Downstream signal processing and calculation steps as explained above, then enable a classification of the object 10 into defined object classes. The objective of a precise and ultrasound-based object classification is achieved by the present invention through the following combination of:
(A) special CNN (convolutional neural network) architecture,
(B) ultrasound-specific feature extraction in preprocessing, for example using wavelet transformation,
(C) (optional) feeding of an additional feature “distance to the object” not before the first CNN layers but as an intermediate feed into the posterior classifier portion of the neural network, and
(D) use of physically motivated data augmentation methods.

With respect to the special CNN architecture, the following can be said:

Ultrasound-based object classification in vehicles and simple electronic devices in real time requires a small CNN. The CNN architecture therefore has to always be specifically adapted to the task in order to be able to achieve very good correct classification rates despite a small CNN.

This is achieved with the following architecture, for example:
1. convolutional layer, 5×7 kernel, padding (low level features), ReLU
2. pooling, 2×2
3. convolutional layer, 1×5 kernel, padding (time domain features), ReLU
4. convolutional layer, 5×1 kernel, padding (frequency domain features), ReLU
5. pooling, 2×2
6. convolutional layer, 3×3 kernel, padding (high level features), ReLU
7. pooling, 2×2
8. convolutional layer, 3×3 kernel, padding (high level features), ReLU
9. concatenation of flattened feature maps and distance feature
10. fully connected layer, ReLU
11. dropout layer
12. fully connected layer, Softmax/Sigmoid

The number of neurons in the fully connected layers depends on the selected input variable of the time-frequency representation and the desired number of classes.

The special features in the CNN architecture of the neural network according to the invention can be presented as follows:
Input is a time-frequency representation of 64×32 pixels, for instance. This achieves a very compact and meaningful representation of features in terms of temporal progression and frequency content.
Specific layers: Use of a separated convolutional layer for time and frequency correlations. This is achieved with special non-square convolution kernels with an atypically small number of trainable parameters, e.g. 1×5 or 5×1, which are not common in image processing or other areas.

Using the method according to the invention makes the probabilities of assignment to one of the object classes available as the output variables of the CNN.

FIG. 3 shows a schematic illustration of training a neural network 9 or a classification of an object using a neural network using the method 100 according to an embodiment example of the present invention. After appropriate training, the neural network 9 is also used to carry out an object classification for an object. A first input variable 6 and, if necessary, at least one second input variable 7 are provided to the neural network 9. These two input variables 6, 7 are processed by the neural network 9 according to the method 100 as explained above, so that an output variable 8 representing object class information 12 for the detected object 10 is output by the neural network 9. The neural network 9 can be part of the ultrasonic sensor 50, but can also be located outside the ultrasonic sensor 50, for example, as part of a cloud or network-based connection or external connection to a data processing device, such as a control unit in a vehicle.

Additional data augmentation methods can be used to make the neural network 9 robust to interference from the outside. These can include:
Distance-dependent white noise to modify the signal-to-noise ratio,
Doppler shifting to simulate movements of the vehicle or objects,
shifts in the time domain to simulate small transit time differences such as those typically caused by random influences in sound fields,
masking of time values or frequency lines to simulate a loss of information on the transmission path,
combining object backscatter from different objects to simulate the presence of multiple objects.
part of this procedure according to the invention is the linking of augmentation methods both in the time domain before training and in the frequency domain during training.

What is claimed is:

1. A method for classifying an object to be detected with at least one ultrasonic sensor, comprising the following steps:
transmitting a first signal, using the at least one ultrasonic sensor, to the object;
receiving a second signal using the at least one ultrasonic sensor, wherein the second signal is a backscattered signal from the object;
processing the second signal into a digital signal;
extracting a selected signal portion from the digital signal, wherein the selected signal portion represents a relevant and time-limited time segment from the digital signal;
transforming the selected signal portion into a two-dimensional feature vector;
feeding the at least one two-dimensional feature vector into a neural network as at least one input variable; and
determining object class information for the object using the neural network, wherein, based on the at least one input variable, the neural network produces an output variable which indicates a probability value for at least one defined object class for the one object.

2. The method according to claim 1, further comprising feeding at least one second input variable into the neural network, wherein the second input variable includes distance information which represents a distance between the at least one ultrasonic sensor and the one object.

3. The method according to claim 2, wherein the distance information is fed as an intermediate feed into a posterior classifier portion of fully connected layers of the neural network.

4. The method according to claim 1, wherein the neural network includes at least one first convolutional layer with a non-square filter kernel, a narrow side of which extends along a time dimension of the feature vector, and a second convolutional layer with a non-square filter kernel, a narrow side of which extends along a frequency dimension of the feature vector.

5. The method according to claim 1, wherein the selected signal portion from the digital signal represents a fixed time period from an ascertained starting point of the digital signal.

6. The method according to claim 1, wherein the selected signal portion is ascertained from the digital signal using a sliding window approach or a pulse-echo method, wherein a window which is shorter than an entire recording length of the digital signal is shifted over the entire recording length of the digital signal.

7. The method according to claim 1, wherein the step of processing the second signal into a digital signal includes filtering the digital signal to improve an S/N ratio.

8. The method according to claim 1, wherein the second signal is configured as an analog signal.

9. A detection system configured to classify an object to be detected, comprising:
at least one ultrasonic sensor which is configured to:
transmit a first signal to the object;
receiving a second signal, wherein the second signal is a backscattered signal from the object;
process the second signal into a digital signal;
extract a selected signal portion from the digital signal, wherein the selected signal portion represents a relevant and time-limited time segment from the digital signal;
transform the selected signal portion into a two-dimensional feature vector;
feed the at least one two-dimensional feature vector into a neural network as at least one input variable; and
determine object class information for the object using the neural network, wherein, based on the at least one input variable, the neural network produces an output variable which indicates a probability value for at least one defined object class for the one object,
wherein the at least one ultrasonic sensor (50) can be used in a vehicle.

10. A non-transitory machine-readable data carrier on which is stored a computer program including machine-readable instructions for classifying an object to be detected with at least one ultrasonic sensor, the instructions, when executed on one or more computers and/or compute instances, causing the one or more computers and/or compute instances to perform the following steps:
transmitting a first signal, using the at least one ultrasonic sensor, to the object;
receiving a second signal using the at least one ultrasonic sensor, wherein the second signal is a backscattered signal from the object;
processing the second signal into a digital signal;
extracting a selected signal portion from the digital signal, wherein the selected signal portion represents a relevant and time-limited time segment from the digital signal;
transforming the selected signal portion into a two-dimensional feature vector;
feeding the at least one two-dimensional feature vector into a neural network as at least one input variable; and
determining object class information for the object using the neural network, wherein, based on the at least one input variable, the neural network produces an output variable which indicates a probability value for at least one defined object class for the one object.

11. One or more computers and/or compute instances configured to classify an object to be detected with at least one ultrasonic sensor, the one or more computers and/or compute instances being configured to:
transmit a first signal, using the at least one ultrasonic sensor, to the object;
receive a second signal using the at least one ultrasonic sensor, wherein the second signal is a backscattered signal from the object;
process the second signal into a digital signal;
extract a selected signal portion from the digital signal, wherein the selected signal portion represents a relevant and time-limited time segment from the digital signal;
transform the selected signal portion into a two-dimensional feature vector;
feed the at least one two-dimensional feature vector into a neural network as at least one input variable; and
determine object class information for the object using the neural network, wherein, based on the at least one input variable, the neural network produces an output variable which indicates a probability value for at least one defined object class for the one object.
